(19) United States
(12) Patent Application Publication
(10) Pub. No.: US 2018/0225489 A1
(43) Pub. Date: Aug. 9, 2018

(54) WIRELESS RING TYPE BARCODE READER

(71) Applicant: Marson Technology Co., Ltd., New Taipei (TW)

(72) Inventors: Kuo-Nien Liou, New Taipei (TW); Kenneth Liou, New Taipei (TW)

(21) Appl. No.: 15/453,449

(22) Filed: Mar. 8, 2017

(30) Foreign Application Priority Data
Feb. 3, 2017 (TW) 106201730

(51) Int. Cl. G06K 7/10; G06K 7/14; G06K 19/06

(52) U.S. Cl. CPC G06K 7/10891; G06K 19/06028; G06K 7/1413; G06K 7/10881

(57) ABSTRACT

A wireless ring type barcode reader is sheathed on a user's finger and provided for a barcode scan operation. The barcode reader is turned on by using a non-mechanical start switch such as a capacitive proximity/touch switch, and a Velcro wrap is installed at the bottom of the reader, and a pad is attached to the Velcro wrap. When the Velcro wrap is fixed to the user's finger, the user's finger touches the pad to avoid discomfort caused by touching the hard plastic housing of the barcode reader

### BACKGROUND OF THE INVENTION

### (a) Field of the Invention

The present invention relates to a barcode reader, more particularly to a wireless ring type barcode reader driven by a non-mechanical start switch and capable of improving the comfort of wearing.

### (b) Description of the Related Art

There are various different types of barcode readers such as ring type readers and handheld readers, wherein the wireless ring type barcode reader is considered to be the most convenient one, and users simply sheathe the wireless ring type barcode reader into the users' finger without the need of holding the reader to scan a barcode, so as to improve the convenience of use. However, the wireless ring type barcode reader has the issue of uncomfortable wearing. Since a general wireless ring type barcode reader has to comply with the ergonomic requirements, therefore most users wear the wireless ring type barcode reader on the users' index finger, and press a button switch by the user's thumb to turn on the reader. The switch is necessary, otherwise the light source of reader must be always lit and battery will be exhausted very soon. In order to fit the barcode reader to different finger sizes of individuals, a Velcro wrap is generally provided for fixing the reader to the finger. If the Velcro wrap is tied too tightly, the users' finger will be hurt due to poor blood circulation. If the Velcro wrap is tied too loosely, the reader may be shifted or crooked easily by the pressing force from the user's thumb while pressing the button switch which all make by mechanical button. In addition, the plastic housing of the barcode reader presses at the users' finger directly and cause discomfort during use. In addition, a general wireless ring type barcode reader is operated by a mechanical button switch, and the mechanical button switch is not easy to use, and the users have to fix and sheathe the reader to the finger securely for the pressing operation,

So a lot of ring readers need a wrist unit to reduce the weight, such as disclosed in U.S. Pat. Nos. 7,942,326 [symbol] 8,317,102 and 9,082,030 entitled Multi-mode ring reader, also U.S. Pat. Nos. 8,235,294 [symbol] 8,702,004 [symbol] 9,104,931 entitled Accuracy-enhanced reader. The above 7 patents all have a numbering 130 wrist unit, due to using a mechanical button switch. The other two U.S. Pat. No. 5,410,140 entitled Mirroless ring mounted miniature optical reader and U.S. Pat. No. 5,578,810 ring mounted miniature optical reader need a separate unit 70 due to using mechanical button 33.

The U.S. Pat. No. 6,015,090 entitled “Hand mountable adaptive barcode reader” also needs a wrist unit 123, The U.S. Pat. No. 6,634,558 entitled “Optical code reader with hand mounted imager” also need a wrist unit 3.

All the above patents need a wrist unit or separate unit with a wire to connect the ring reader in order to tie the reader tightly and avoid the reader don't be shifted by press the mechanical button switch. The wrist unit and separate unit are inconvenient. So a true practical wireless ring type barcode reader should not use mechanical switch button but none in the world until now.

There are two types of non-mechanical button switch, one is infrared Sensing but it need milli-ampere current consumption in standby mode and will exhaust battery soon, The other type is capacitive proximity/touch switch which only need micro-ampere in standby mode, So it is suitable for this application but none in the market is using it.

### SUMMARY OF THE INVENTION

Therefore, it is a primary objective of the present invention to provide a wireless ring type barcode reader capable of improving the comfort of wearing and using a non-mechanical switch such as a capacitive proximity or a touch switch as a start switch.

To achieve the aforementioned and other objectives, the present invention provides a wireless ring type barcode reader comprising a housing, a scan engine module installed in the housing and electrically coupled to a non-mechanical start switch (such as a capacitive proximity or a touch switch) outside the housing and provided for a user to drive the scan engine module to operate and perform a barcode scan operation, and a wing is formed and extended downwardly and separately from both sides of the housing, and a through hole is formed on the wing for passing both ends of a Velcro wrap, so that the Velcro wrap is normally fixed to the bottom of the housing, and a pad is attached to the Velcro wrap, and the pad is made of a soft material. When a user wears the wireless ring type reader, the user's finger may touch the pad directly to avoid the discomfort caused by pressing the housing at the user's finger, so as to improve the comfort of wearing effectively.

### BRIEF DESCRIPTION OF THE FIGURES

FIG. 1 is a first perspective view of the present invention;

FIG. 2 is a second schematic perspective view of the present invention;

FIG. 3 is the first schematic view of a preferred embodiment of the present invention;

FIG. 4 is the second schematic view of a preferred embodiment of the present invention;

FIG. 5 is the third schematic view of a preferred embodiment of the present invention; and

FIG. 6 is the fourth schematic view of a preferred embodiment of the present invention.

### DETAILED DESCRIPTION OF THE PREFERRED EMBODIMENT

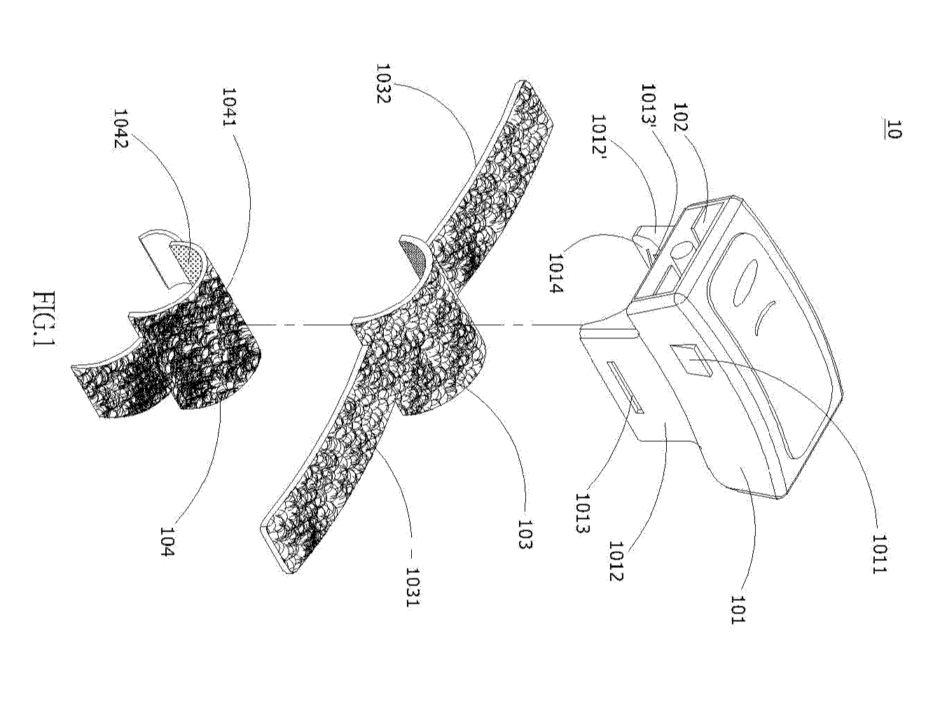

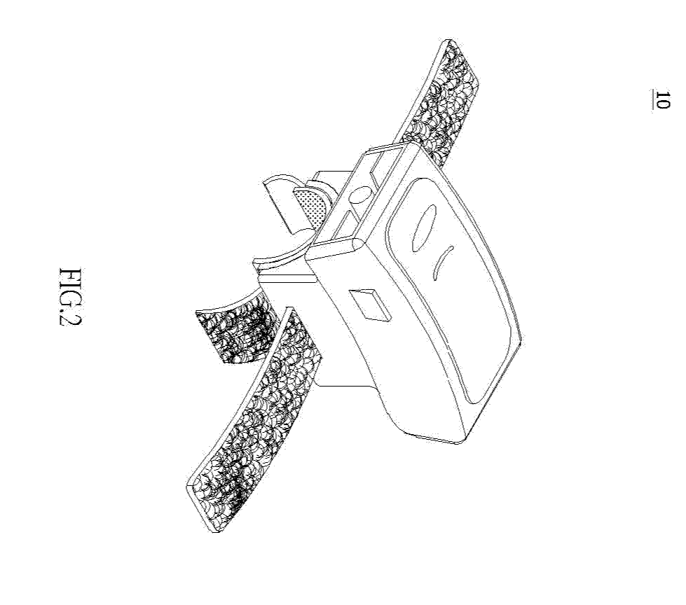

With reference to FIG. 1 for a wireless ring type barcode reader 10 of the present invention, the wireless ring type barcode reader 10 comprises a housing 101, a scan engine module 102, a Velcro wrap 103 and a pad 104, wherein the housing 101 is hollow and has a non-mechanical start switch 1011 (such as a capacitive proximity or touch switch) installed at external edges of the housing 101 separately respectively and provided for the purpose of left-handed or right-handed use. In addition, a wing 1012, 1012′ is formed and extended downwardly and separately from both opposite sides of the housing 101, and a through hole 1013, 1013′ is formed on the wing 1012, 1012′, and a wearing portion 1014 is formed between the two wings 1012, 1012′, and the wearing portion 1014 matches the arc shape of the finger, so that the housing 101 is in compliance with the ergonomic requirements of the user's wearing. The scan engine module 102 is installed inside the housing 101 and provided for a barcode scan operation, and the scan engine module 102 is electrically coupled to the non-mechanical start switch 1011, and the user may drive the scan engine module 102 to operate through the non-mechanical start switch 1011. The Velcro wrap 103 is primarily made of a flexible material, and both ends of the Velcro wrap 103 are passed through the two through holes (1013, 1013′) respectively, so that the Velcro wrap 103 is normally fixed to the bottom of the housing 101, and a first adhesive layer 1031 is formed on a side of the Velcro wrap 103 and a relative adhesive layer 1032 is formed on the other side of the Velcro wrap, and the first adhesive layer 1031 and the relative adhesive layer 1032 are attached and fixed to each other. The pad 104 has a second adhesive layer 1041 formed on a side of the pad 104 for attaching the relative adhesive layer 1032 of the Velcro wrap 103 and a contact layer 1042 formed on the other side of the pad 104, and the pad is made of a soft material, so that when the contact layer 1042 is in contact with a user's finger, the discomfort caused by a long time of use can be avoided. The aforementioned components are combined to form the wireless ring type barcode reader 10 of the present invention as shown in FIG. 2. In addition, the wireless ring type barcode reader 10 of the present invention could have no wire connection to other device.

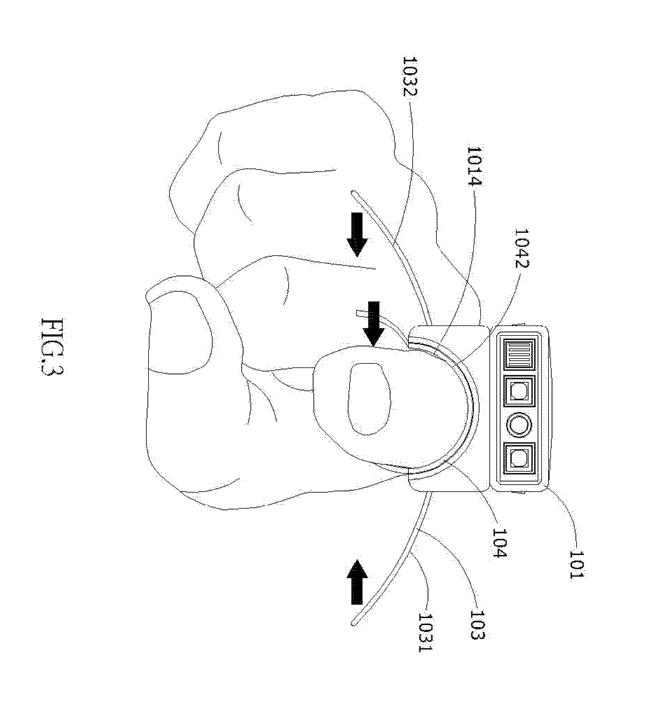

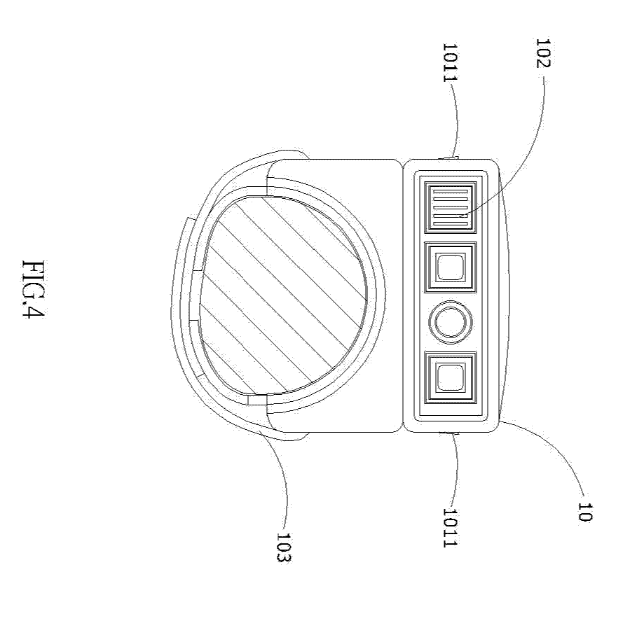

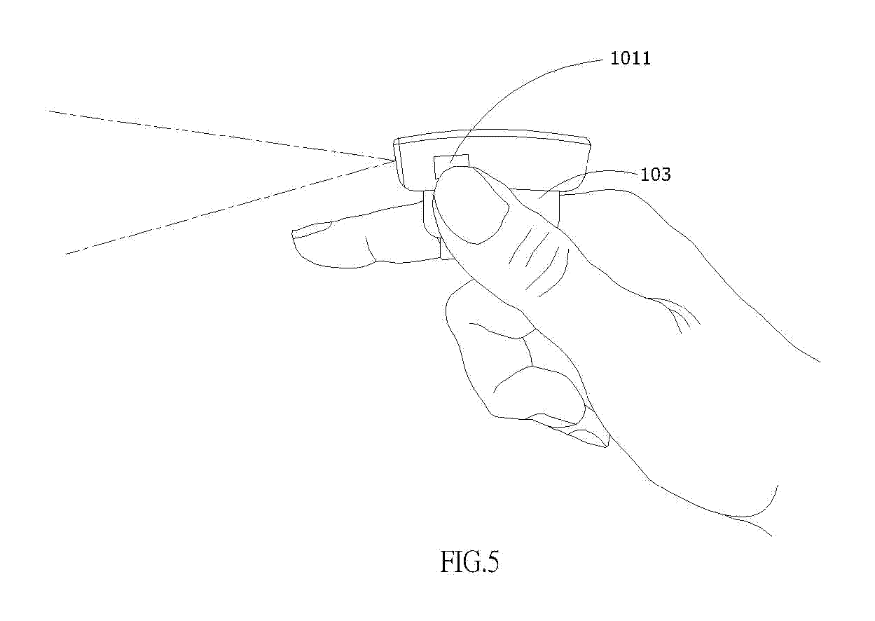

With reference to FIG. 3 together with FIG. 1 for a preferred embodiment of the present invention, the Velcro wrap 103 is installed to the housing 101 first, and then the pad 104 is attached onto the Velcro wrap 103, and the contact layer 1042 of the pad 104 is placed on the surface of the user's finger, and then one of the ends of the Velcro wrap 103 is wound around the finger, and the relative adhesive layer 1032 at the other end of the Velcro wrap 103 is attached to the first adhesive layer 1031, so that the first adhesive layer 1031 and relative adhesive layer 1032 of the Velcro wrap 103 are attached to each other, and the Velcro wrap 103 is wound around and fixed to the user's finger. When the Velcro wrap 103 is wound and fixed to the user's finger, the pad 104 is comprised by the finger, so that the pad 104 is embedded into the wearing portion 1014 of the housing 101 to improve the comfort of wearing. The mode of fixing the barcode reader to the user's finger according to the present invention is shown in FIG. 4, wherein the wireless ring type barcode reader 10 is fixed to the user's finger by the Velcro wrap 103, and then the user may use a thumb to start the non-mechanical start switch 1011 to drive the scan engine module 102 to operate and perform a barcode scan operation. In the non-mechanical start switch 1011 of the present invention, a capacitive proximity or touch switch may be adopted as long as the switch can be started by getting closer to the housing or touching the housing, so as to avoid the issue of pushing or shifting the reader by the pressing pressure of the mechanical switch, and the user may use the thumb to drive the scan engine module 102 to operate through the non-mechanical start switch 1011 as shown in FIG. 5. As described above, the use of the non-mechanical start switch 1011 in accordance with the present invention can avoid the situation of tying the Velcro wrap too tightly and prevent hurting the finger caused by poor blood circulation, so as to improve the comfort of wearing.

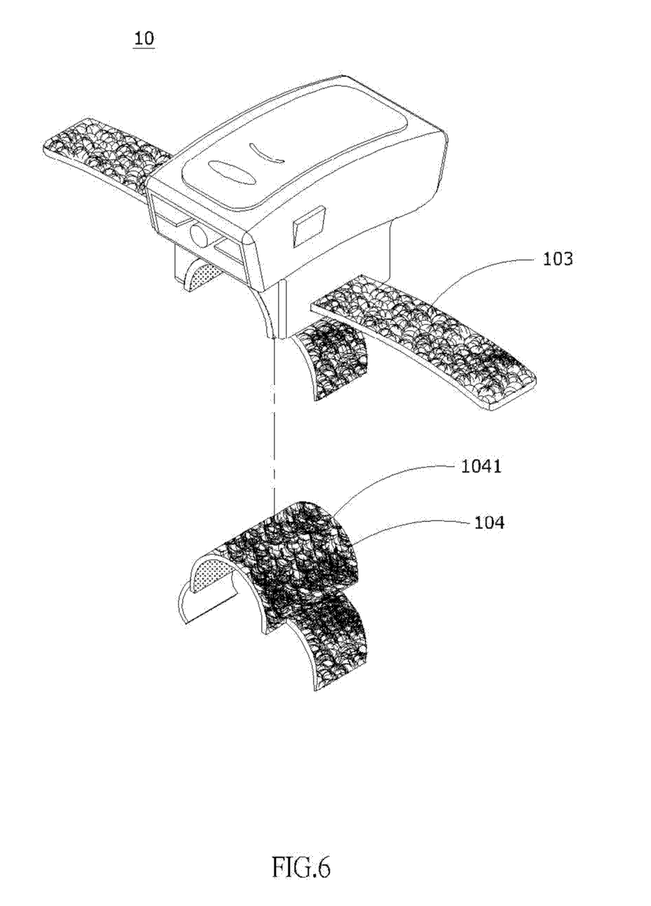

With reference to FIG. 6, bacteria or dirt may be accumulated on the Velcro wrap 103 and the pad 104 after the wireless ring type barcode reader 10 of the present invention has been worn and used for a period of time. Therefore, the Velcro wrap 103 and the pad 104 of the present invention are detachable, so that users change the Velcro wrap 103 and/or the pad 104. For example, a user may tear the pad 104 off from the Velcro wrap 103, replace the old pad 104 with a new one, and attach the second adhesive layer 1041 of the pad 104 to the Velcro wrap 103 to complete the replacement of the pad 104. The user may change the Velcro wrap 103 by the aforementioned method as well. Both Velcro wrap 103 and pad 104 of the present invention are detachable to facilitate maintenance, and the pad 104 provides better comfort to users.

In summation, the present invention reduces the discomfort of wearing by the pad, and the non-mechanical start switch is a capacitive proximity or touch switch, so that the implementation of the present invention has the effects of improving the comfort of wearing and using the capacitive proximity or touch switch as the start switch.

Many changes and modifications in the above-described embodiments of the invention can, of course, be carried out without departing from the scope thereof. Accordingly, to promote the progress in science and the useful arts, the invention is disclosed and is intended to be limited only by the scope of the appended claims.

What is claimed is:

1. A Tireless ring type barcode reader, sheathed on a user's finger, comprising:
a housing, being hollow, and having a non-mechanical start switch installed on each side of the housing, and a wing formed and extended downwardly and separately from both opposite sides of the housing, and the wing having a through hole formed thereon;
a scan engine module, installed in the housing, and electrically coupled to the non-mechanical start switch;
a Velcro wrap, made of a flexible material, and having a first adhesive layer on a side of the Velcro wrap and a relative adhesive layer on the other side of the Velcro wrap, and the first adhesive layer and the relative adhesive layer being attached and fixed to each other, and both ends of the Velcro wrap being passed through the two through holes respectively and fixed to the bottom of the housing; and
a pad, having a second adhesive layer on a side of the pad, and provided for attaching the relative adhesive layer;
thereby, after the Velcro wrap is fixed to the user's finger, the pad is situated between the Velcro wrap and the finger, and the user may drive and operate the scan engine module by a thumb through the non-mechanical start switch to perform a barcode scan operation.

2. The wireless ring type barcode reader of claim 1, wherein the non-mechanical start switch is a capacitive proximity switch.

3. The wireless ring type barcode reader of claim 1, wherein the non-mechanical start switch is a capacitive touch switch.

4. The wireless ring type barcode reader of claim 1, wherein a wearing portion is formed between the two wings, and the wearing portion is in a shape matching the arc shape of the finger.

5. The wireless ring type barcode reader of claim 1, wherein a contact layer is formed on the other side of the pad and primarily made of a soft material.

6. The wireless ring type barcode reader of claim 1, wherein the ring type barcode reader has no wire connection to other device.
